(19) United States
(12) Patent Application Publication
(10) Pub. No.: US 2022/0244377 A1
(43) Pub. Date: Aug. 4, 2022

(54) INSPECTION SYSTEM AND INSPECTION METHOD

(71) Applicant: NEC Corporation, Minato-Ku, Tokyo (JP)

(72) Inventors: Masayuki ARIYOSHI, Tokyo (JP); Shingo YAMANOUCHI, Tokyo (JP); Kazumine OGURA, Tokyo (JP); Tatsuya SUMIYA, Tokyo (JP)

(73) Assignee: NEC Corporation, Minato-Ku, Tokyo (JP)

(21) Appl. No.: 17/626,199

(22) PCT Filed: Jul. 22, 2019
(86) PCT No.: PCT/JP2019/028672

§ 371 Date: Jan. 11, 2022

(51) Int. Cl. G01S 13/89; E06B 3/90

(52) U.S. Cl. CPC G01S 13/89; E06B 3/90

(57) ABSTRACT

An inspection system uses radio waves to inspect the state of an object at low cost and efficiently, the foregoing possible as a result of the system comprising: a measurement unit that measures reflected waves from an object making a prescribed movement, the waves having been generated by projecting radio waves to the object; a moving body that comprises the measurement unit and moves so that the relative positional relationship between the measurement unit and the object changes with the passage of time; and a generation unit that generates information representing the state of the object by performing signal processing on a signal indicated by the reflected waves.

### TECHNICAL FIELD

The present invention relates to a technique for inspecting a state of an object using a radio wave.

### BACKGROUND ART

In recent years, threats of urban crime and terrorism tend to increase, and the importance of enhancing security for important facilities such as an airport has increased. Along with this, expectations for a technique for inspecting whether luggage carried by a person entering such an important facility is a dangerous article have increased.

As a technique related to such a technique, PTL 1 discloses an inspection system in which a passage is provided between scanning panels of an antenna element array and an inspection of a subject is performed while the subject passes through the passage. Each of the antenna elements in this system controls several phase delays so as to irradiate a subject with a microwave beam, and receives the reflected microwave beam reflected from the subject.

In addition, PTL 2 discloses a method for detecting a potential dangerous article or an explosive hidden under clothing or in baggage. In this method, a three-dimensional image of a target area is generated through irradiation, reflection, and reception of microwave radiation. This method uses the generated image to show a contour of a moving person and any dielectric objects that the person is likely to be hiding while wearing it. Then, the method determines a path of microwave passing through concealment by measuring a phase and amplitude of the microwave reflected from the dielectric object, thereby generating a three-dimensional microwave image of a target region.

In addition, PTL 3 discloses a device that inspects whether a large number of inspection targets are dangerous articles by automatic determination. This device irradiates a person with a millimeter wave, and then receives a reflected wave reflected from the person to output amplitude (luminance information). This device generates a two-dimensional image including matrix-shaped pixels based on the luminance information. Then, the device determines the presence or absence of a dangerous article based on the reflectance of the reflected wave based on the luminance information, an area ratio of pixels having a predetermined reflectance or more in the entire two-dimensional image, and a degree of connection of pixels having the predetermined reflectance or more in the entire two-dimensional image.

### CITATION LIST

### Patent Literature

[PTL 1] JP 5358053 B2
[PTL 2] JP 2017-508949 A
[PTL 3] JP 2009-222580 A

### SUMMARY OF INVENTION

### Technical Problem

In a device such as a body scanner that inspects whether baggage carried (worn) by a person entering an important facility is a dangerous article, it is detected that the baggage is the dangerous article by measuring the reflected wave from the subject to be inspected generated by irradiating the subject with a radio wave such as a microwave or a millimeter wave.

In a case where the body scanner includes, for example, a sensor that irradiates the radio wave and measures the reflected wave over the entire surface configured to cover the subject to be inspected, since the entire portion of the subject to be inspected can be inspected by one measurement, the time required for the inspection is reduced. However, in this case, since a large number of sensors are required, there is a problem in that the cost increases.

Conversely, in a case where the body scanner includes the sensor, for example, only on a specific surface facing the direction in which the subject to be inspected is located, the number of sensors is reduced as compared with a case where the body scanner includes the sensor over the entire surface configured to cover the subject to be inspected, and thus, the cost is reduced. However, in this case, in order to inspect the entire portion of the subject to be inspected, it is necessary to perform measurement a plurality of times while causing the subject to be inspected to change the orientation of the body with respect to the specific surface, and therefore, there is a problem in that the time required for the inspection becomes long, and the efficiency of the inspection decreases.

That is, it is an issue to inspect a state of an object (subject to be inspected) using a radio wave in important facilities and the like at low cost and efficiently. PTLs 1 to 3 described above do not particularly make reference to such a problem. A main object of the present invention is to provide an inspection system and the like that solve this problem.

### Solution to Problem

An inspection system according to an aspect of the present invention includes: a measurement means configured to measure a reflected wave from an object that performs predetermined movement, the reflected wave being generated by irradiating the object with a radio wave; a moving body including the measurement means and configured to move such that a relative positional relationship between the measurement means and the object changes with a lapse of time; and a generation means configured to generate information indicating a state of the object by performing signal processing on a signal indicated by the reflected wave.

In another respect to achieve the above object, an inspection method according to an aspect of the present invention includes: disposing a measurement means configured to measure a reflected wave from an object that performs predetermined movement, the reflected wave being generated by irradiating the object with a radio wave, on a moving body moving such that a relative positional relationship between the measurement means and the object changes with a lapse of time; and generating information indicating a state of the object by performing signal processing on a signal indicated by the reflected wave.

### Advantageous Effects of Invention

According to the present invention, it is possible to inspect a state of an object using a radio wave at low cost and efficiently.

### BRIEF DESCRIPTION OF DRAWINGS

FIG. 1 is a block diagram illustrating a configuration of an inspection system 1 according to a first example embodiment of the present invention.

FIG. 2 is a bird's-eye view of a revolving door module 11 illustrated in FIG. 1 as viewed from the front side.

FIG. 3 is a diagram illustrating a transition of a relative positional relationship between an array sensor 111 installed in a revolving door 110 and a subject 10 according to the first example embodiment of the present invention.

FIG. 4 is a flowchart illustrating an operation of the inspection system 1 according to the first example embodiment of the present invention.

FIG. 5 is a diagram illustrating revolving door modules 11A to 11D different from the revolving door module 11 according to the first example embodiment of the present invention.

FIG. 6 is a diagram illustrating a configuration related to the revolving door module 11 in a case where the inspection system 1 according to the first example embodiment of the present invention includes a plurality of revolving door modules 11.

FIG. 7 is a diagram illustrating a positional relationship between an array sensor 211 and a subject 20 in an inspection system 2 according to a modification of the first example embodiment of the present invention.

FIG. 8 is a block diagram illustrating a configuration of an inspection system 3 according to a second example embodiment of the present invention.

FIG. 9 is a block diagram illustrating a configuration of an information processing apparatus 900 capable of executing an inspection system control device 12 according to the first example embodiment of the present invention or a generation unit 33 according to the second example embodiment.

### EXAMPLE EMBODIMENT

Hereinafter, example embodiments of the present invention will be described in detail with reference to the drawings. Note that in the following description, a revolving door module 11 and the like to be described later will be described with a three-dimensional (X-Y-Z) coordinate space appropriately in the drawings for convenience of description. In each example embodiment described below, overlooking (seeing) in a negative direction of a Z axis is defined as “overlooking from an upper surface side”, and overlooking in a positive direction of a Y axis is defined as “overlooking from a front surface side”.

### First Example Embodiment

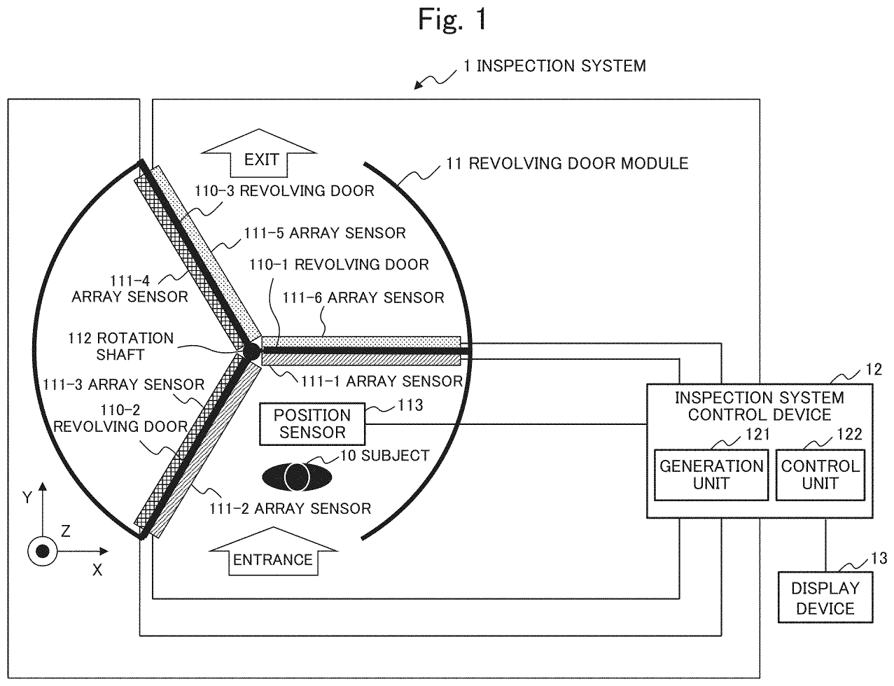

FIG. 1 is a block diagram illustrating a configuration of an inspection system 1 according to a first example embodiment of the present invention. The inspection system 1 is, for example, a system that inspects a state of a subject 10 (object) entering an important facility such as an airport, more specifically, whether a dangerous article is included in belongings of the subject 10.

The inspection system 1 generally includes a revolving door module 11, an inspection system control device 12, and a display device 13. The revolving door module 11 and the inspection system control device 12 are communicably connected. Note that a display of a three-dimensional coordinate space in FIG. 1 is ignored for the inspection system control device 12 and the display device 13.

The inspection system control device 12 is, for example, an information processing apparatus such as a server device or a personal computer, and includes a generation unit 121 and a control unit 122. A hardware configuration of the inspection system control device 12 and operations of the generation unit 121 and the control unit 122 will be described later.

The display device 13 is, for example, a device such as a monitor, and displays information output from the inspection system control device 12.

The revolving door module 11 includes an entrance and an exit. The subject 10 can enter an important facility by moving (performing predetermined movement) in a positive direction of a Y axis illustrated in FIG. 1 in the revolving door module 11 from the entrance (movement start place) toward the exit (movement end place).

The revolving door module 11 includes three revolving doors 110-1 to 110-3 (moving bodies), a rotation shaft 112, and a position sensor 113 (position information collection unit). Note that, in the present example embodiment, in the following description, the revolving doors 110-1 to 110-3 may be collectively referred to as a revolving door 110.

The position sensor 113 collects data for detecting that the subject 10 enters the revolving door module 11, and collects data (position information) indicating the position of the subject 10 in the revolving door module 11. The position sensor 113 may be, for example, an infrared sensor, a pressure sensor embedded in a floor of the revolving door module 11, or the like. Alternatively, the position sensor 113 may be a camera that captures an inside of the revolving door module 11. The position sensor 113 transmits data indicating that the subject 10 has been detected to have entered the revolving door module 11 and data indicating the position of the subject 10 to the inspection system control device 12.

Note that the revolving door module 11 may not include the position sensor 113. In that case, the inspection system 1 may use, for example, data collected by array sensors 111-1 to 111-6 described later instead of the data collected by the position sensor 113 described above. Alternatively, in a case where the revolving door module 11 does not include the position sensor 113, the array sensors 111-1 to 111-6 (measurement units) to be described later may be operated at all times and continuously measured regardless of the entrance and exit of the subject 10 into and from the revolving door module 11 or a position of the subject 10.

The rotation shaft 112 is formed in a vertical direction or a substantially vertical direction (a direction parallel or substantially parallel to a Z axis) in the vicinity of a movement path when the subject 10 moves in the revolving door module 11 in parallel or substantially parallel to the ground (XY plane). Note that, in the present example embodiment, in the following description, parallel or substantially parallel may be simply referred to as “parallel”, and vertical or substantially vertical may be simply referred to as “vertical”.

The revolving door 110 according to the present example embodiment revolves, for example, to the left (that is, revolves counterclockwise as viewed from the upper surface side) around the rotation shaft 112 with respect to the direction in which the subject 10 moves. Alternatively, the revolving door 110 may revolve, for example, to the right (that is, revolves clockwise as viewed from the upper surface side) around the rotation shaft 112 with respect to the direction in which the subject 10 moves.

The revolving doors 110-1 to 110-3 revolve such that an angle formed by the revolving door 110-1 and the revolving door 110-2 and an angle formed by the revolving door 110-1 and the revolving door 110-3 are maintained at about 120° on the XY plane. That is, in the revolving door module 11, three spaces substantially equally divided by the revolving doors 110-1 to 110-3 revolve to the left around the rotation shaft 112 with respect to the direction in which the subject 10 moves.

The subject 10 enters one of the above-described three spaces from the entrance of the revolving door module 11, and moves to the exit of the revolving door module 11 as the space revolves around the rotation shaft 112. In the example illustrated in FIG. 1, the subject 10 enters a space divided by the revolving door 110-1 and the revolving door 110-2.

As illustrated in FIG. 1, the revolving door 110-1 includes the array sensors 111-1 and 111-6 (measurement units), the revolving door 110-2 includes the array sensors 111-2 and 111-3, and the revolving door 110-3 includes the array sensors 111-4 and 111-5. Note that, in the present example embodiment, in the following description, the array sensors 111-1 to 111-6 may be collectively referred to as an array sensor 111. Note that the number of array sensors 111 is not limited to six (six sets).

The revolving door 110 may include the array sensor 111 on a surface of a surface forming the revolving door 110, or may include the array sensor 111 in a form embedded inside the revolving door 110.

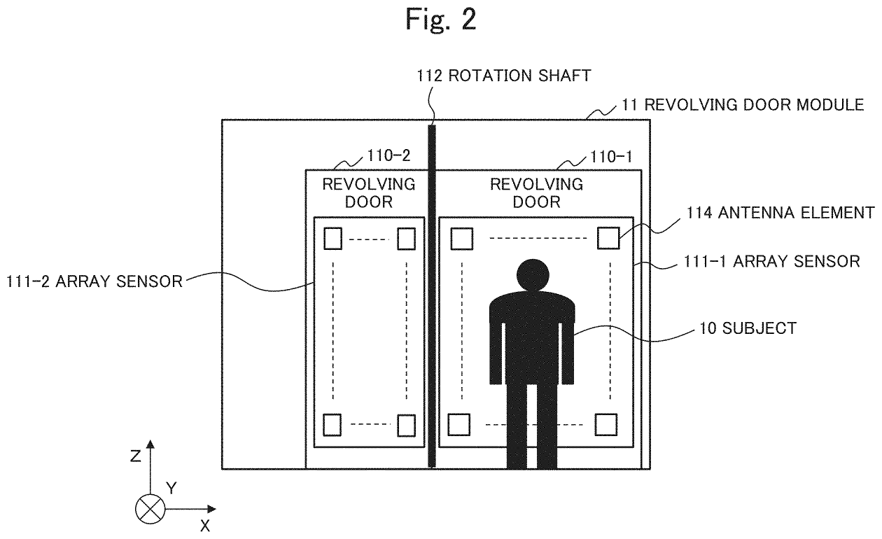

FIG. 2 is a bird's-eye view of the revolving door module 11 illustrated in FIG. 1 as viewed from the front side. The array sensor 111-1 provided on the revolving door 110-1 located parallel to the XZ plane includes a plurality of antenna elements 114 two-dimensionally arranged in the X-axis direction and the Z-axis direction. Similar to the array sensor 111-1, the array sensors 111-2 to 111-6 also include a plurality of two-dimensionally arranged antenna elements 114. Note that the number of antenna elements 114 in the X-axis direction and the Z-axis direction arranged two-dimensionally is determined depending on the mode (for example, the size of the revolving door 110, the size of the space separated by the revolving door 110, and the like) of the revolving door module 11.

When the revolving door 110 is made of a material having a transparency higher than the reference, the antenna element 114 may be made of a transparent material such as a glass antenna.

The antenna element 114 has a function of irradiating the subject 10 with a radio wave such as a microwave and a millimeter wave, and measuring (receiving) the reflected wave from the subject 10 generated by irradiating the radio wave. That is, the antenna element 114 included in the array sensor 111 are disposed on the surface or inside of the revolving door 110 so as to irradiate the subject 10 with the radio wave and measure the reflected wave from the subject 10. Note that, in the present example embodiment, in the following description, irradiating the subject 10 with the radio wave such as the microwave or millimeter wave and measuring the reflected wave from the subject 10 generated by irradiating the radio wave may be referred to as “scanning the subject 10”.

The irradiation of the subject 10 with the radio wave and the measurement of the reflected wave by the antenna element 114 are controlled by the control unit 122 in the inspection system control device 12 illustrated in FIG. 1.

The control unit 122 in the inspection system control device 12 starts the control of the array sensor 111 when the position sensor 113 detects that the subject 10 enters the revolving door module 11.

The control unit 122 estimates the position of the subject 10 in the revolving door module 11 based on the data received from the position sensor 113 and necessary for estimating the position of the subject 10 in the revolving door module 11. The control unit 122 controls each antenna element 114 included in the array sensor 111 so as to irradiate the spatial measurement area including the estimated position with the radio wave. The antenna element 114 irradiates the radio wave to the subject 10 under the control of the control unit 122. Note that the irradiation area of the radio wave by the antenna element 114 may be variable according to the position of the subject 10 in the space divided by the revolving door 110, or may be fixed within a range that can cover the space.

In this case, the individual antenna elements 114 irradiate the subject 10 with the radio wave one by one in order based on the order instructed by the control unit 122. Then, the reflected wave from the subject 10 generated by the irradiation of the radio wave is measured by the plurality of (for example, all) antenna elements 114 included in the array sensor 111.

The control unit 122 also controls the array sensor 111 so as to scan the subject 10 individually present in three spaces divided by the revolving door 110 in parallel. That is, the control unit 122 controls the array sensor 111 for each combination of the following three combinations in parallel: combination of array sensors 111-1 and 111-2, combination of array sensors 111-3 and 111-4, and combination of array sensors 111-5 and 111-6. Note that the array sensor 111 does not necessarily form a pair in the space (interior) divided by the revolving door 110, and may be installed only on one side in the room, for example.

In this case, in order to prevent the accuracy of inspection from being reduced due to leaking radio waves or reflected waves in a certain space to another space (due to interference between radio waves and reflected waves related to different spaces), the control unit 122 performs control such as using different frequencies for each space or irradiating radio waves at different timings for each space. Note that, for example, in a case where the revolving door 110 or the like includes a shielding material that prevents the radio wave or the reflected wave in a certain space from leaking to another space, the control unit 122 may omit the above-described control.

The array sensor 111 transmits a signal indicated by the measured reflected wave from the subject 10 to the inspection system control device 12.

The generation unit 121 in the inspection system control device 12 performs signal processing such as spectrum analysis on the signal indicated by the reflected wave from the subject 10 received from the array sensor 111 to generate an image representing a shape of an article possessed by the subject 10. Alternatively, the generation unit 121 may perform signal processing on the signal indicated by the reflected wave from the subject 10 to generate information different from the image representing the characteristics of the article possessed by the subject 10. Examples of the information different from the image representing the characteristics of the article possessed by the subject 10 include information representing the type (blade, firearm, or the like) of the article possessed by the subject 10 and a type of substances (metal or the like) constituting the article. The generation unit 121 can generate the information by, for example, collating a result of performing the signal processing with a database related to the result.

The generation unit 121 inputs, to the display device 13, information different from the generated image representing the shape of the article possessed by the subject 10 or the generated image representing the characteristic of the article possessed by the subject 10. The display device 13 displays the information input by the generation unit 121 on a display screen or the like. As a result, an inspector in an important facility can inspect whether the subject 10 possesses a suspicious object.

In addition, the generation unit 121 may generate information indicating an article possessed by the subject 10 by integrating a result of signal processing performed on a signal indicated by a reflected wave measured by repeatedly scanning the subject 10 by the array sensor 111 under the control of the control unit 122. Further, the control unit 122 may control the array sensor 111 to repeatedly scan the subject 10 at predetermined time intervals. For example, in a case where the predetermined time interval is 30 milliseconds, the generation unit 121 can generate a moving image representing the article possessed by the subject 10.

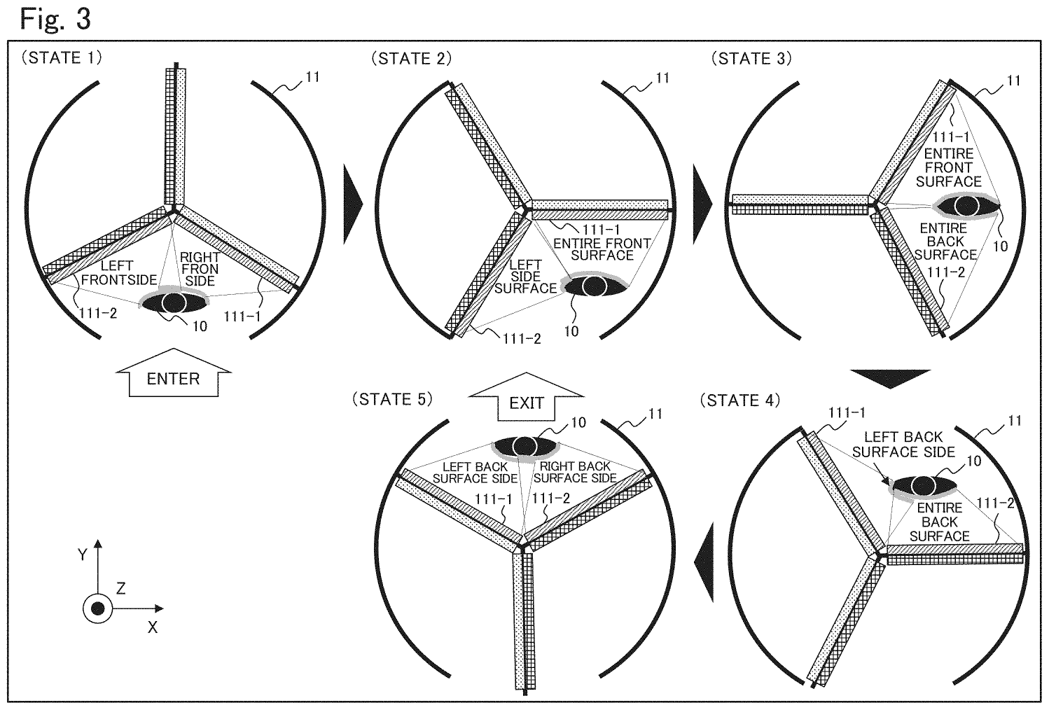

Next, the transition of the relative positional relationship between the array sensor 111 installed in the revolving door 110 and the subject 10 according to the present example embodiment will be described in detail with reference to FIG. 3. FIG. 3 illustrates that the relative positional relationship between the array sensor 111 and the subject 10 changes in order from State 1 to State 5 with a lapse of time.

State 1 in FIG. 3 represents the relative positional relationship between the array sensor 111 and the subject 10 immediately after the subject 10 enters the revolving door module 11. In State 1, the array sensor 111-1 scans a right front portion of the subject 10, and the array sensor 111-2 scans a left front portion of the subject 10.

State 2 in FIG. 3 represents the relative positional relationship between the array sensor 111 and the subject 10 when the subject 10 slightly moves from the position in State 1 toward the exit of the revolving door module 11. In State 2, the array sensor 111-1 scans the entire front surface of the subject 10, and the array sensor 111-2 scans a left side surface of the subject 10.

State 3 in FIG. 3 represents the relative positional relationship between the array sensor 111 and the subject 10 when the subject 10 further moves from the position in State 2 toward the exit of the revolving door module 11. In State 3, the array sensor 111-1 scans the entire front surface of the subject 10, and the array sensor 111-2 scans the entire back surface of the subject 10.

State 4 in FIG. 3 represents the relative positional relationship between the array sensor 111 and the subject 10 when the subject 10 further moves from the position in State 3 toward the exit of the revolving door module 11. In State 4, the array sensor 111-1 scans the left back portion of the subject 10, and the array sensor 111-2 scans the entire back portion of the subject 10.

State 5 in FIG. 3 represents the relative positional relationship between the array sensor 111 and the subject 10 immediately before the subject 10 further moves from the position in State 4 toward the exit of the revolving door module 11 and exits from the revolving door module 11. In State 5, the array sensor 111-1 scans the left back portion of the subject 10, and the array sensor 111-2 scans the right back portion of the subject 10.

As described above with reference to FIG. 3, the array sensors 111-1 and 111-2 according to the present example embodiment scan almost the entire portion of the subject 10 by utilizing the fact that the relative positional relationship with the subject 10 changes with a lapse of time while the subject 10 moves in the revolving door module 11 from the entrance toward the exit. That is, the revolving door 110 according to the present example embodiment moves such that the proportion of the portion of the subject 10 irradiated with the radio wave by the array sensor 111 to the entire portion of the subject 10 satisfies the reference (for example, 95% or more). Note that, although FIG. 3 illustrates an example in which the subject 10 always moves with the front face thereof facing the exit direction, the array sensor 111 can scan almost the entire portion of the subject 10 even in a case where the subject 10 moves while changing the direction of the front face thereof with respect to the exit direction little by little according to the path in the revolving door module 11.

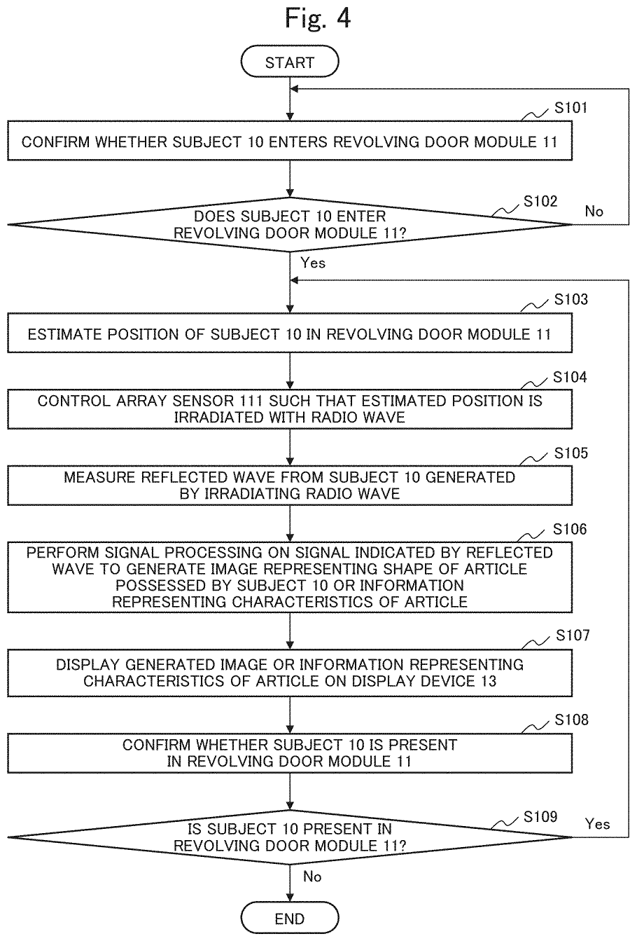

Next, an operation (processing) of the inspection system 1 according to the present example embodiment will be described in detail with reference to a flowchart of FIG. 4.

The control unit 122 in the inspection system control device 12 confirms whether the subject 10 has entered the revolving door module 11 based on the data collected by the position sensor 113 (step S101). When the subject 10 has not entered the revolving door module 11 (No in step S102), the process returns to step S101.

When the subject 10 enters the revolving door module 11 (Yes in step S102), the control unit 122 estimates the position of the subject 10 in the revolving door module 11 based on the data collected by the position sensor 113 (step S103).

The control unit 122 controls the array sensor 111 to irradiate the spatial measurement area including the subject 10 present at the estimated position with the radio wave (step S104). The array sensor 111 measures the reflected wave from the subject 10, the reflected wave being generated by the irradiation of the radio wave (step S105).

The generation unit 121 in the inspection system control device 12 performs signal processing on the signal indicated by the reflected wave measured by the array sensor 111 to generate an image representing the shape of the article possessed by the subject 10 or information representing the characteristics of the article (step S106). The generation unit 121 displays the generated image or the information indicating the characteristics of the article on the display device 13 (step S107).

The control unit 122 confirms whether the subject 10 is present in the revolving door module 11 based on the data collected by the position sensor 113 (step S108). When the subject 10 is present in the revolving door module 11 (Yes in step S109), the process returns to step S103. When the subject 10 is not present in the revolving door module 11 (No in step S109), the entire process ends.

The inspection system 1 according to the present example embodiment can efficiently inspect the state of the object using the radio wave at low cost. This is because, in the inspection system 1, the array sensor 111 that measures the reflected wave generated by irradiating the subject 10 performing the predetermined movement with the radio wave is included in the revolving door 110 that moves so that the relative positional relationship between the array sensor 111 and the subject 10 changes with a lapse of time.

Hereinafter, effects achieved by the inspection system 1 according to the present example embodiment will be described in detail.

In a case where a body scanner that inspects belongings or the like of a person entering an important facility includes, for example, a large number of sensors arranged to cover the subject to be inspected, since the inspection can be completed by one measurement, the time required for the inspection is small, but there is a problem in that the cost increases due to the necessity of a large number of sensors. Conversely, in a case where the body scanner includes a sensor only on a specific surface facing the direction in which the subject to be inspected is located, for example, the number of sensors is reduced, so that the cost is reduced. However, there is a problem in that the efficiency of the inspection is reduced because it is necessary to perform measurement a plurality of times while causing the subject to be inspected to change the orientation of the body.

In view of such a problem, the inspection system 1 according to the present example embodiment includes the array sensor 111 that is an example of a measurement unit, the revolving door 110 that is an example of a moving body, and the generation unit 121, and operates as described above with reference to FIGS. 1 to 4, for example. That is, the array sensor 111 measures the reflected wave from the subject 10 generated by irradiating the subject 10 performing the predetermined movement with the radio wave. The revolving door 110 includes the array sensor 111, and moves such that the relative positional relationship between the array sensor 111 and the subject 10 changes with a lapse of time. Then, the generation unit 121 generates information indicating the state of subject 10 by performing the signal processing on the signal indicated by the reflected wave.

That is, the inspection system 1 according to the present example embodiment uses the fact that how the subject 10 moves is known in advance (the movement of the subject 10 can be assumed), and for example, as illustrated in FIG. 3, can combine the movement of the subject 10 and the movement of the array sensor 111 itself to efficiently scan the entire portion of the subject 10 without requiring a large number of sensors.

Then, since the inspection system 1 according to the present example embodiment uses a movement action necessary for the subject 10 to enter the important facility, that is, to move from the entrance to the exit of the revolving door module 11, the subject 10 does not need to perform a dedicated action (for example, changing the orientation of the body relative to the sensor, etc.) for the physical examination. As a result, the inspection system 1 can efficiently inspect the subject 10.

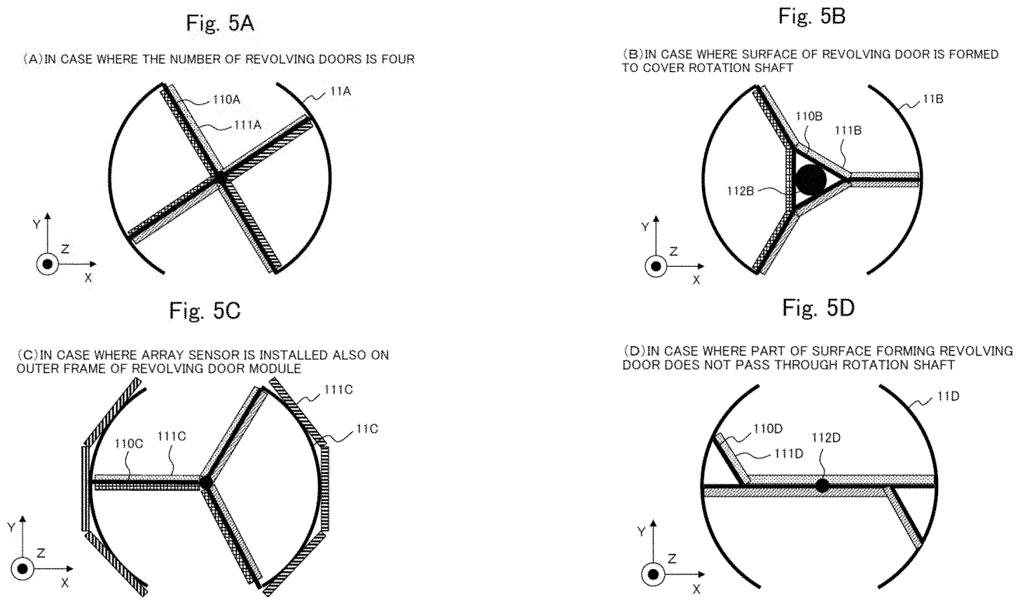

In addition, the aspect of the revolving door module 11 according to the present example embodiment is not limited to the aspect illustrated in FIG. 1 or 3. The inspection system 1 according to the present example embodiment may include, for example, at least one of the revolving door modules 11A to 11D that are exemplified in FIG. 5 and different from the revolving door module 11 described above.

The revolving door module 11A illustrated in FIG. 5(A) includes four revolving doors 111A including an array sensor 110A. Further, the number of revolving doors included in the revolving door module in the inspection system 1 may be two or five or more.

A revolving door module 11B illustrated in FIG. 5(B) includes an array sensor 111B and a revolving door 110B having a surface formed so as to cover a rotation shaft 112B. In the revolving door module 11B, the revolving door 110B provided with the array sensor 111B that emits radio wave in each of the three spaces divided by the revolving door 110B has three planes. As a result, the inspection system 1 including the revolving door module 11B can further expand a scannable range (increase a coverage ratio regarding the scan range).

A revolving door module 11C illustrated in FIG. 5(C) includes an array sensor 111C installed also on an outer frame of the revolving door module 11C in addition to the revolving door 110C. As a result, the inspection system 1 including the revolving door module 11C can further expand the scannable range.

The revolving door module 11D illustrated in FIG. 5(D) includes a revolving door 110D such that a part of a surface forming the revolving door 110D including the array sensor 111D does not pass through the rotation shaft 112D. As a result, the inspection system 1 including the revolving door module 11D has the same function and effect as when including the revolving door module 11 described above, and can further widen the individual spaces divided by the revolving door 110D.

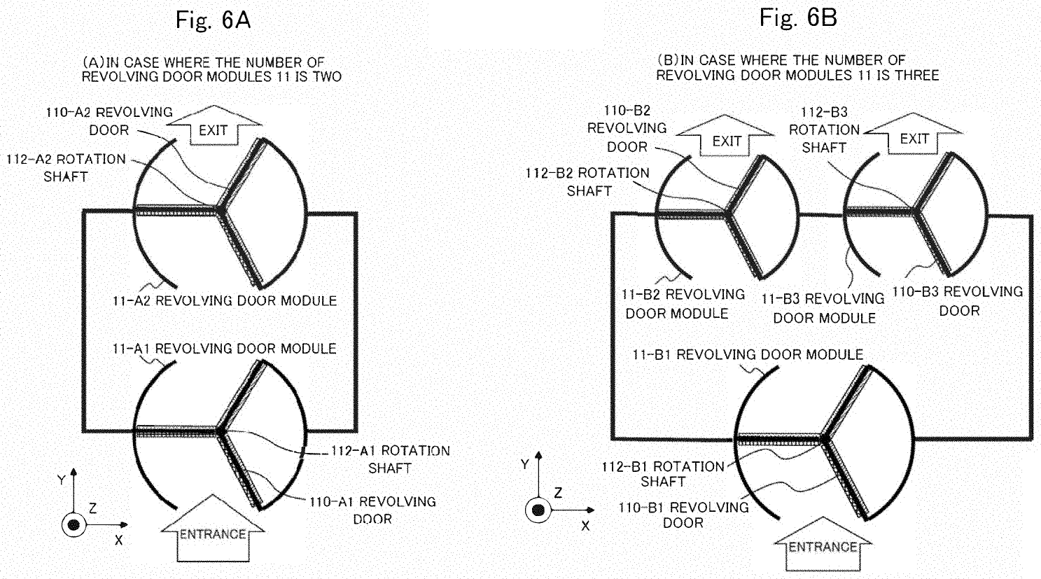

In addition, the number of revolving door modules 11 included in the inspection system 1 according to the present example embodiment may not be one. For example, as illustrated in FIG. 6, the inspection system 1 according to the present example embodiment may include a plurality of revolving door modules 11.

FIG. 6(A) illustrates a case where the number of revolving door modules 11 included in the inspection system 1 is two. In this case, the inspection system 1 includes revolving door modules 11-A1 and 11-A2. The revolving door module 11-A1 includes a rotation shaft 112-A1 (first rotation shaft) and a revolving door 110-A1 (first revolving door) that revolves around the rotation shaft 112-A1. The revolving door module 11-A2 includes a rotation shaft 112-A2 (second rotation shaft) and a revolving door 110-A2 (second revolving door) that revolves around the rotation shaft 112-A2.

When the inspection system 1 has the configuration illustrated in FIG. 6(A), the subject 10 enters through the entrance of the revolving door module 11-A1, moves inside the revolving door modules 11-A1 and 11-A2 in the positive direction of the Y axis, and then exits through the exit of the revolving door module 11-A2.

In this case, the rotation modes of the revolving door 110-A1 and the revolving door 110-A2 may be the same or different from each other. More specifically, for example, when the rotation modes are different from each other, the revolving door 110-A1 revolves to the left (that is, revolves counterclockwise as viewed from the upper surface side) with respect to the direction in which the subject 10 moves, and the revolving door 110-A2 revolves to the right (that is, revolves clockwise as viewed from the upper surface side) with respect to the direction in which the subject 10 moves. In this case, since the combination of the movement of the subject 10 and the movement of the array sensor 111 itself is two sets, the inspection system 1 can increase the coverage ratio regarding the scan range.

FIG. 6(B) illustrates a case where the number of revolving door modules 11 included in the inspection system 1 is three. In this case, the inspection system 1 includes revolving door modules 11-B1, 11-B2, and 11-B3. The revolving door module 11-B1 includes a rotation shaft 112-B1 (first rotation shaft) and a revolving door 112-B1 (first revolving door) that revolves around the rotation shaft 110-B1. The revolving door module 11-B2 includes a rotation shaft 112-B2 (second rotation shaft) and a revolving door 110-B2 (second revolving door) that revolves around the rotation shaft 112-B2. The revolving door module 11-B3 includes a rotation shaft 112-B3 (second rotation shaft) and a revolving door 110-B3 (second revolving door) that revolves around the rotation shaft 112-B3.

When the inspection system 1 has the configuration illustrated in FIG. 6(B), the subject 10 enters through the entrance of the revolving door module 11-B1, moves inside the revolving door module 11-B1 in the positive direction on the Y-axis, further moves inside the revolving door module 11-B2 or 11-B3 in the positive direction on the Y-axis, and then exits through the exit of the revolving door module 11-B2 or 11-B3.

In this case, the rotation modes of the revolving door 110-B1 and the revolving door 110-B2 may be the same or different from each other, and the rotation modes of the revolving door 110-B1 and the revolving door 110-B3 may be the same or different from each other. More specifically, for example, the revolving door 110-B1 revolves to the left with respect to the direction in which the subject 10 moves, and the revolving doors 110-B2 and 110-B3 revolve to the right with respect to the direction in which the subject 10 moves. In this case, since the combination of the movement of the subject 10 and the movement of the array sensor 111 itself is two sets similarly to the case of FIG. 6(A), the inspection system 1 can increase the coverage ratio regarding the scan range.

In addition, the number of the revolving door modules 11 included in the inspection system 1 according to the present example embodiment may be four or more, and the positional relationship among the plurality of revolving door modules 11 may be different from the positional relationship illustrated in FIG. 6.

In addition, the technology included in the inspection system 1 according to the present example embodiment described above is also applicable to an inspection system that does not include the revolving door module 11.

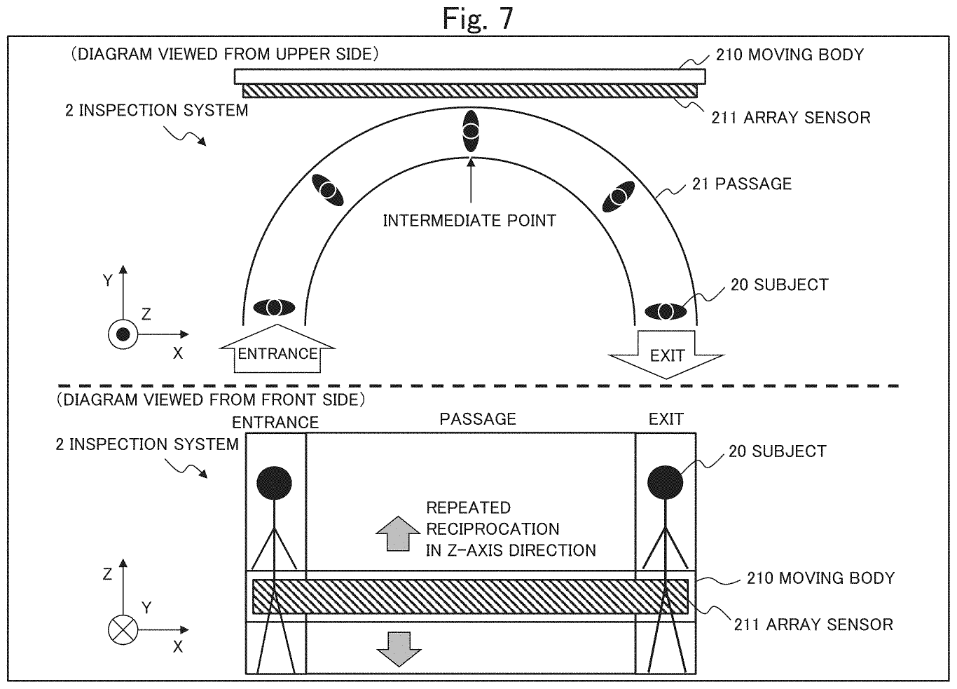

FIG. 7 is a diagram illustrating a positional relationship between an array sensor 211 and a subject 20 in an inspection system 2 according to the modification of the present example embodiment.

The inspection system 2 includes a moving body 210 and an array sensor 211. Note that, although the inspection system 2 also includes the inspection system control device 12 and the display device 13 (not illustrated in FIG. 7) similarly to the inspection system 1 described above, the operation of the inspection system control device 12 and the display device 13 in the inspection system 2 is similar to that of the inspection system 1, and thus the description of the operation is omitted.

In the inspection system 2, the subject 20 moves from the entrance to the exit of the passage 21 formed in a semicircular shape in the XY plane viewed from the upper surface side. The moving body 210 is located at a position on the Y-axis positive direction side with respect to the passage 21 in parallel with the X-axis. The moving body 210 includes the array sensor 211 that scans the subject 20.

The moving body 210 repeatedly reciprocates in the Z-axis direction. The time (cycle) required for the moving body 210 to make one round trip in the Z-axis direction is, for example, half the time normally required for the subject 20 to move from an entrance to an exit of a passage 21. That is, the moving body 210 reciprocates twice in the Z-axis direction until the subject 20 moves from the entrance to the exit of the passage 21.

Therefore, the array sensor 211 according to the present modification scans from a front surface portion to a left side surface portion of the subject 20 while the subject 20 moves from the entrance of the passage 21 to an intermediate point of the passage 21. Then, the array sensor 211 scans from a left side surface portion to a back surface portion of the subject 20 while the subject 20 moves from the intermediate point of the passage 21 to the exit of the passage 21.

Therefore, similarly to the inspection system 1 described above, the inspection system 2 according to the present modification can efficiently scan the entire portion of the subject 20 without requiring a large number of sensors by using the fact that the movement of the subject 20 can be assumed and combining the movement of the subject 20 and the movement of the array sensor 211 itself.

In addition, the technology included in the inspection system 1 according to the present example embodiment described above can also be applied to areas other than the security inspection in important facilities and the like, and for example, can also be applied to a system that performs quality inspection of products in factories and the like. In this case, the system that performs the quality inspection of the product inspects the state of the product surface (for example, the presence or absence of a scratch or the like) of the product that is being moved by, for example, a belt conveyor or the like using a sensor whose position is movable.

### Second Example Embodiment

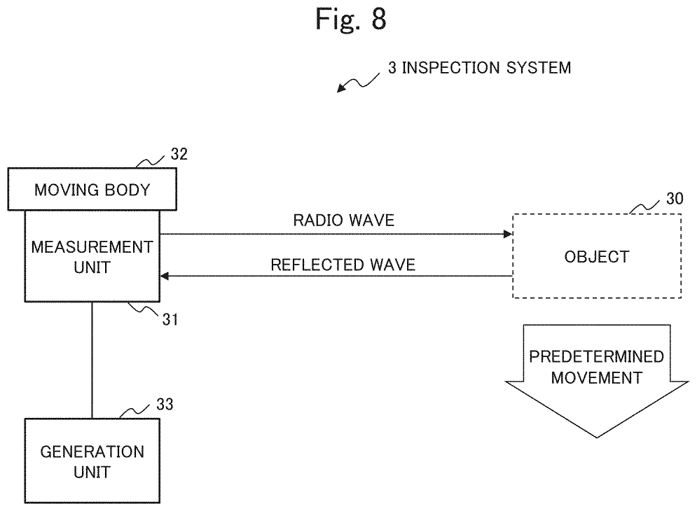

FIG. 8 is a block diagram illustrating a configuration of an inspection system 3 according to a second example embodiment of the present invention; and The inspection system 3 includes a measurement unit 31, a moving body 32, and a generation unit 33.

The measurement unit 31 measures a reflected wave from an object 30 generated by irradiating the object 30 performing the predetermined movement with a radio wave. The measurement unit 31 may be, for example, the array sensor 111 according to the first example embodiment described above.

The moving body 32 includes the measurement unit 31, and moves such that a relative positional relationship between the measurement unit 31 and the object 30 changes with a lapse of time. The moving body 32 may be, for example, the revolving door 110 according to the first example embodiment described above.

The generation unit 33 performs signal processing on a signal indicated by the reflected wave to generate information indicating a state of the object 30.

The inspection system 3 according to the present example embodiment can efficiently inspect the state of the object using the radio wave at low cost. This is because, in the inspection system 3, the measurement unit 31 that measures the reflected wave generated by irradiating the object 30 performing predetermined movement with the radio wave is provided in the moving body 32 that moves such that the relative positional relationship between the measurement unit 31 and the object 30 changes with a lapse of time.

<Hardware Configuration Example>

Each unit in the inspection system control device 12 illustrated in FIG. 1 or the device that implements the generation unit 33 illustrated in FIG. 8 in each of the above-described example embodiments can be implemented by dedicated hardware (HW) (electronic circuit). In addition, in FIGS. 1 and 8, at least the following configuration can be regarded as a functional (processing) unit (software module) of a software program.
Generation units 121 and 33,
Control unit 122.

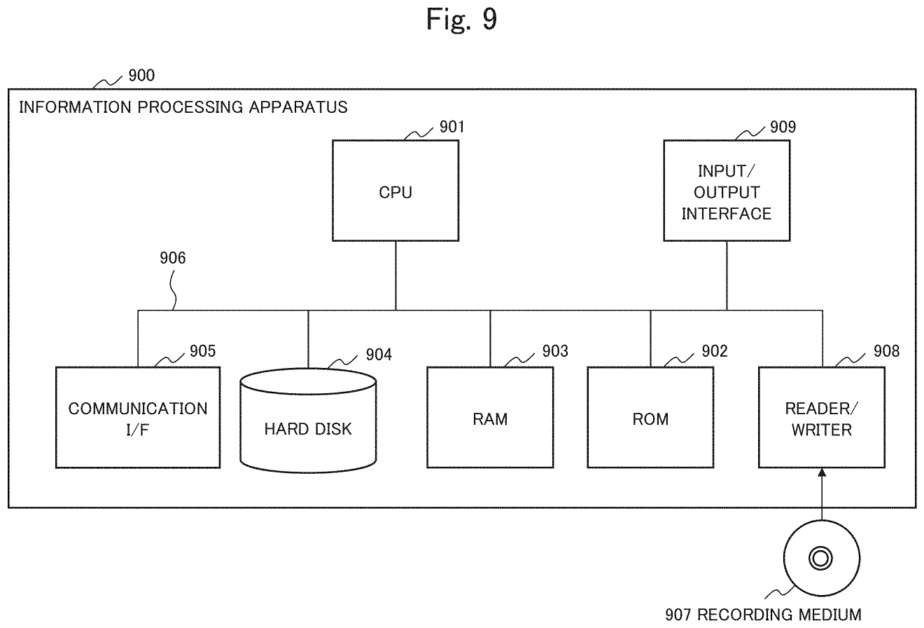

However, the division of each unit illustrated in these drawings is a configuration for convenience of description, and various configurations can be assumed at the time of implementation. An example of hardware environment in this case will be described with reference to FIG. 9.

FIG. 9 is a diagram exemplarily describing a configuration of an information processing apparatus 900 (computer) capable of executing the inspection system control device 12 according to the first example embodiment of the present invention or the generation unit 33 according to the second example embodiment. That is, FIG. 9 is a configuration of a computer (information processing apparatus) capable of constructing the inspection system control device 12 and the generation unit 33 of FIGS. 1 and 8, and represents a hardware environment capable of implementing each function in the above-described example embodiment.

The information processing apparatus 900 illustrated in FIG. 9 includes the following components as constituent elements.
Central processing unit (CPU) 901;
Read only memory (ROM) 902;
Random access memory (RAM) 903;
Hard disk (storage device) 904;
Communication interface 905;
Bus 906 (communication line);
Reader/writer 908 capable of reading and writing data stored in a recording medium 907 such as compact disk read only memory (CD-ROM);
Input/output interface 909 such as monitor, speaker, or keyboard

That is, the information processing apparatus 900 including the above-described components is a general computer to which these components are connected via the bus 906. The information processing apparatus 900 may include a plurality of CPUs 901 or may include a CPU 901 configured by multiple cores.

Then, the present invention described using the above-described example embodiment as an example supplies a computer program capable of implementing the following functions to the information processing apparatus 900 illustrated in FIG. 9. The function is the above-described configuration in the block configuration diagram (FIGS. 1 and 8) referred to in the description of the example embodiment or the function of the flowchart (FIG. 4). Thereafter, the present invention is achieved by reading, interpreting, and executing the computer program on the CPU 901 of the hardware. In addition, the computer program supplied into the device may be stored in a readable/writable volatile memory (RAM 903) or a nonvolatile storage device such as the ROM 902 or the hard disk 904.

Furthermore, in the above case, a general procedure can be adopted at present as a method of supplying the computer program into the hardware. Examples of the procedure include a method of installing a program in an apparatus via various recording media 907 such as a CD-ROM, a method of downloading a program from the outside via a communication line such as the Internet, and the like. In such a case, the present invention can be understood to be constituted by a code constituting the computer program or the recording medium 907 storing the code.

Hereinabove, the present invention has been described above using the above-described example embodiments. However, the present invention is not limited to the above-described example embodiments. That is, the present invention can apply various aspects that can be understood by those skilled in the art within the scope of the present invention.

Note that some or all of the above-described example embodiments can also be described as the following supplementary notes. However, the present invention exemplarily described by the above-described example embodiments is not limited to the following.

(Supplementary Note 1)

An inspection system, including:

a measurement means configured to measure a reflected wave from an object that performs predetermined movement, the reflected wave being generated by irradiating the object with a radio wave;

a moving body that includes the measurement means and configured to move such that a relative positional relationship between the measurement means and the object changes with a lapse of time; and a generation means configured to perform signal processing on a signal indicated by the reflected wave to generate information indicating a state of the object.

(Supplementary Note 2)

The inspection system described in Supplementary Note 1,

wherein the moving body moves such that a ratio of a portion of the object irradiated with the radio wave by the measurement means to an entire object satisfies a reference until the object moves from a movement start place to a movement end place in the predetermined movement.

(Supplementary Note 3)

The inspection system described in Supplementary Note 1 or 2, wherein the moving body is a revolving door that revolves around a rotation shaft formed in a vertical or substantially vertical direction in a vicinity of a movement path where the object performs the predetermined movement in parallel or substantially parallel to the ground, and

the measurement means is disposed in the revolving door in such a way as to irradiate the object with the radio wave and measure the reflected wave from the object.

(Supplementary Note 4)

The inspection system described in Supplementary Note 3, further including:

a first revolving door configured to revolve around a first rotation shaft and a second revolving door configured to revolve around a second rotation shaft,

wherein a mode of rotation is different between the first revolving door and the second revolving door.

(Supplementary Note 5)

The inspection system described in Supplementary Note 4,

wherein the first and second revolving doors are different from each other with respect to a rotation direction with respect to a direction in which the object moves.

(Supplementary Note 6)

The inspection system described in any one of Supplementary Notes 3 to 5,

wherein the measurement means irradiates the object with the radio wave, the object existing in each of a plurality of spaces divided by a plurality of revolving doors revolving around the same rotation shaft, and specifications for irradiating the radio wave are different for each of the spaces.

(Supplementary Note 7)

The inspection system described in Supplementary Note 6,

wherein the measurement means irradiates the radio wave such that an irradiation timing or a frequency to be used is different for each of the spaces.

(Supplementary Note 8)

The inspection system described in any one of Supplementary Notes 3 to 7,

wherein the revolving door is made of a material having transparency higher than a reference, and

the measurement means includes a glass antenna.

(Supplementary Note 9)

The inspection system described in any one of Supplementary Notes 1 to 8, further including:

a position information collection means configured to collect position information indicating a position of the object,

wherein the measurement means irradiates a spatial measurement area including a position indicated by the position information with the radio wave.

(Supplementary Note 10)

The inspection system described in any one of Supplementary Notes 1 to 9,

wherein the generation means generates at least one of an image representing a shape of the object and information different from an image representing a characteristic of the object.

(Supplementary Note 11)

The inspection system described in any one of Supplementary Notes 1 to 10,

wherein the measurement means repeatedly measures the reflected wave generated by repeatedly irradiating the object with the radio wave, and

the generation means generates the information representing the state of the object by integrating a result of the signal processing performed on the signal indicated by the reflected wave repeatedly measured.

(Supplementary Note 12)

The inspection system described in Supplementary Note 11,

wherein the measurement means performs the irradiation of the radio wave to the object and the measurement of the reflected wave at predetermined time intervals, and

the generation means generates a moving image representing the state of the object.

(Supplementary Note 13)

The inspection system described in any one of Supplementary Notes 1 to 12, further including:

a display device configured to display the information representing-a the state of the object generated by the generation means.

(Supplementary Note 14)

An inspection method, including:

disposing a measurement means configured to measure a reflected wave from an object that performs predetermined movement, the reflected wave being generated by irradiating the object with a radio wave, on a moving body moving such that a relative positional relationship between the measurement means and the object changes with a lapse of time; and

generating information indicating a state of the object by performing signal processing on a signal indicated by the reflected wave.

### REFERENCE SIGNS LIST

1 inspection system
10 subject
11 revolving door module
11A to 11D revolving door module
11-A1 revolving door module
11-A2 revolving door module
11-B1 revolving door module
11-B2 revolving door module
11-B3 revolving door module
110-1 to 110-3 revolving door
110A revolving door
110B revolving door
110C revolving door
110D revolving door
110-A1 revolving door
110-A2 revolving door
110-B1 revolving door
110-B2 revolving door
110-B3 revolving door
111-1 to 111-6 array sensor
112 rotation shaft
112B rotation shaft
112D rotation shaft
112-A1 rotation shaft
112-A2 rotation shaft
112-B1 rotation shaft
112-B2 rotation shaft
112-B3 rotation shaft
113 position sensor
114 antenna element
12 inspection system control device
121 generation unit
122 control unit
2 inspection system
20 subject
21 passage
210 moving body
211 array sensor
3 inspection system
30 object
31 measurement unit
32 moving body
33 generation unit
900 information processing apparatus
901 CPU
902 ROM
903 RAM
904 hard disk (storage device)
905 communication interface
906 bus
907 recording medium
908 reader writer
909 input/output interface

1. An inspection system, comprising:
measurement device configured to measure a reflected wave from an object that performs predetermined movement, the reflected wave being generated by irradiating the object with a radio wave;
a moving body that includes the measurement device and configured to move such that a relative positional relationship between the measurement device and the object changes with a lapse of time;
at least one memory storing a computer program; and
at least one processor configured to execute the computer program to
perform signal processing on a signal indicated by the reflected wave to generate information indicating a state of the object.

2. The inspection system according to claim 1,
wherein the moving body moves such that a ratio of a portion of the object irradiated with the radio wave by the measurement device to an entire object satisfies a reference until the object moves from a movement start place to a movement end place in the predetermined movement.

3. The inspection system according to claim 1,
wherein the moving body is a revolving door that revolves around a rotation shaft formed in a vertical or substantially vertical direction in a vicinity of a movement path where the object performs the predetermined movement in parallel or substantially parallel to the ground, and
the measurement device is disposed in the revolving door in such a way as to irradiate the object with the radio wave and measure the reflected wave from the object.

4. The inspection system according to claim 3, further comprising:
a first revolving door configured to revolve around a first rotation shaft and a second revolving door configured to revolve around a second rotation shaft,
wherein a mode of rotation is different between the first revolving door and the second revolving door.

5. The inspection system according to claim 4,
wherein the first and second revolving doors are different from each other with respect to a rotation direction with respect to a direction in which the object moves.

6. The inspection system according to claim 3,
wherein the measurement device irradiates the object with the radio wave, the object existing in each of a plurality of spaces divided by a plurality of revolving doors revolving around the same rotation shaft, and specifications for irradiating the radio wave are different for each of the spaces.

7. The inspection system according to claim 6,
wherein the measurement device irradiates the radio wave such that an irradiation timing or a frequency to be used is different for each of the spaces.

8. The inspection system according to claim 3,
wherein the revolving door is made of a material having transparency higher than a reference, and
the measurement device includes a glass antenna.

9. The inspection system according to claim 1, further comprising:
a position information collection device configured to collect position information indicating a position of the object,
wherein the measurement device irradiates a spatial measurement area including a position indicated by the position information with the radio wave.

10. The inspection system according to claim 1,
wherein the processor is configured to execute the computer program to generate at least one of an image representing a shape of the object and information different from an image representing a characteristic of the object.

11. The inspection system according to claim 1,
wherein the measurement device repeatedly measures the reflected wave generated by repeatedly irradiating the object with the radio wave, and
the processor is configured to execute the computer program to generate the information representing the state of the object by integrating a result of the signal processing performed on the signal indicated by the reflected wave repeatedly measured.

12. The inspection system according to claim 11,
wherein the measurement device performs the irradiation of the radio wave to the object and the measurement of the reflected wave at predetermined time intervals, and
the processor is configured to execute the computer program to generate a moving image representing the state of the object.

13. The inspection system according to claim 1, further comprising:
a display device configured to display the information representing the state of the object generated.

14. An inspection method, comprising:
disposing a measurement device configured to measure a reflected wave from an object that performs predetermined movement, the reflected wave being generated by irradiating the object with a radio wave, on a moving body moving such that a relative positional relationship between the measurement device and the object changes with a lapse of time; and
generating information indicating a state of the object by performing signal processing on a signal indicated by the reflected wave.
